(19) United States
(12) Patent Application Publication
(10) Pub. No.: US 2005/0188332 A1
(43) Pub. Date: Aug. 25, 2005

(54) Color key presentation for a graphical user interface

(76) Inventor: Robert S. Kolman, Longmont, CO (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/782,983

(22) Filed: Feb. 20, 2004

(51) Int. Cl. G06F 3/00

(52) U.S. Cl. 715/822; 715/821; 715/860

(57) ABSTRACT

A graphical user interface with a selection menu having an inherent color key implemented therein is presented. The selection menu displays a plurality of selectable menu items each associated with different characteristics of possible elements to be displayed in an image rendering space of the display screen. Each menu item is associated with a different unique rendering color. In one embodiment, all possible elements are displayed. In another embodiment, only elements corresponding to selected menu items are displayed, and elements corresponding to unselected items are not displayed. In both embodiments, upon selection of one or more of the menu items, the elements possessing the characteristics associated with the selected menu items are rendered using the different unique rendering color of its associated menu item. Each menu item may be rendered using its associated different unique rendering color regardless of the selection status of the menu item, or alternatively, each menu item may be rendered using a default color if not selected, and using its associated different unique rendering color if selected.

### BACKGROUND OF THE INVENTION

The present invention relates generally to graphical presentation of computerized information, and more particularly to a technique for presenting a color key corresponding to rendering colors of elements of different types presented in a graphical user interface.

Graphical user interfaces are used in computerized systems to facilitate input and output of information between a computerized device and a human operator of the device. An ideal graphical user interface (GUI) is easily navigable, provides straightforward input format, and presents information received from the computerized device in a format easily understandable by a human operator.

A typical GUI will present differing types of information on a display monitor. In some applications, the GUI must provide visual differentiation between certain types of information presented on the display monitor. Visual differentiation may be achieved through use of different colors for each type of information, use of differing line thickness or pattern, use of differing shapes or icon images, etc.

Typically, a selection interface is provided and presented as some form of list (e.g., a drop-down list). Items in the list identify an information type and may have a selection option such as a radio button, a checkbox, or some other standard selection mechanism.

For example, in a GUI which presents elements corresponding to a plurality of different types of information, a highlight selection interface may be provided to allow the operator to highlight elements on the screen according to the elements' type. Suppose, for example, a plurality of elements are displayed where each element may be one of three different information types. Suppose further that the GUI provides a highlight selection interface that allows the operator to select one or more of the three information types to be highlighted. If the operator selects one of the information types for highlighting, elements on the screen corresponding to the selected information type are correspondingly highlighted using some method of visual differentiation discussed above.

One straightforward method for visually differentiating a highlighted element is through the use of color. Thus, if only one information type is highlighted, the GUI might use one particular color for rendering highlighted elements and another different color for rendering the remaining non-highlighted elements. If more than one information type is highlighted, the GUI might assign different colors to each of the highlighted information types (which also differ from the non-highlighted element rendering color).

It will be appreciated, however, that if more than one color is used to differentiate elements of different information types, then in order to convey to the operator the meaning of the color (e.g., color A is assigned to elements of information type 1 and color B is assigned to elements of information type 2), there must be some type of color key provided to avoid confusion. Furthermore, it is desirable if the color key is present on the screen along with the image displayed for maximum ease of deciphering the meaning of the different colors.

However, as known by those skilled in the art, because screen space for displaying images is limited, screen space efficiency must be maximized in terms of space allocation.

Accordingly, a need exists for an improved technique for presenting a color key for a selected plurality of types of information presented in a graphical user interface. Furthermore, it would be desirable if the improved technique would provide the color key without using additional screen space resources.

### SUMMARY OF THE INVENTION

The present invention is an improved technique for presenting a color key inherent in a selection menu for visually differentiating various selected graphical elements presented in a graphical user interface without using additional screen space resources.

According to the invention, a plurality of selectable graphical identifiers are presented in a selection menu of a graphical user interface on a display screen. Each selectable graphical identifier is associated with one or more characteristics of elements to be displayed, and each is also associated with a different unique rendering color that is used to render elements having the one or more characteristics associated with the selectable graphical identifier in an image rendering space of the display screen when the associated graphical identifier is selected.

Upon detection of a newly selected menu item that is not currently selected, elements having the one or more characteristics associated with the selectable graphical identifier are rendered in the image rendering space of the display screen using the different unique rendering color associated with the newly selected graphical identifier. Optionally, the newly selected graphical identifier is re-rendered from a default color to the different unique rendering color associated with the newly selected graphical identifier. Alternatively, all selectable graphical identifiers are always rendered using their associated different unique rendering colors.

Upon detection of a de-selection of a menu item that is currently selected, elements having the one or more characteristics associated with the selectable graphical identifier are either removed from the image rendering space of the display screen, or are re-rendered using a default color different than any of the different unique rendering colors associated with any of the menu items. Optionally, the newly de-selected graphical identifier is re-rendered to a default color.

Because elements corresponding to selected menu items are always rendered using the unique rendering color with which its associated menu item is rendered when selected, the invention provides an inherent color key for distinguishing between displayed items having different characteristics without requiring any additional screen space.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram of a system in which the invention may operate;

FIG. 2 is a block diagram of the computer of FIG. 1 that may execute the method of the invention;

FIG. 3 is a process model implementing an example of a GUI image illustrating a plurality of elements of different element types;

FIG. 4 is a first embodiment of a graphical user interface window implemented in accordance with the present invention having a selection menu with inherent color key illustrating selection of no elements;

FIG. 5 is the graphical user interface window of FIG. 4 with selection menu illustrating selection of a single element type;

FIG. 6 is the graphical user interface window of FIG. 4 with selection menu illustrating selection of two different element types;

FIG. 7 is the graphical user interface window of FIG. 4 with selection menu illustrating selection of all available different element types;

FIG. 8A is a flowchart illustrating a preferred embodiment of a method for implementing the inherent color key of the selection menu of FIGS. 4-7;

FIG. 8B is a flowchart illustrating a preferred embodiment of a method for implementing detected changes in the selection menu of FIGS. 4-7;

FIG. 9 is a second embodiment of a graphical user interface window implemented in accordance with the present invention having a highlight selection menu with inherent color key illustrating selection of no elements;

FIG. 10 is the graphical user interface window of FIG. 9 with highlight selection menu illustrating selection of a single element type;

FIG. 11 is the graphical user interface window of FIG. 9 with highlight selection menu illustrating selection of two different element types;

FIG. 12 is the graphical user interface window of FIG. 9 with highlight selection menu illustrating selection of all available different element types;

FIG. 13A is a flowchart illustrating a preferred embodiment of a method for implementing the inherent color key in the selection menu of FIGS. 9-12 in a graphical user interface; and

FIG. 13B is a flowchart illustrating a preferred embodiment of a method for implementing detected changes in the selection menu of FIGS. 9-12.

### DETAILED DESCRIPTION

The present invention is an improved technique for presenting a color key for a selected plurality of types of information presented in a graphical user interface without using additional screen space resources.

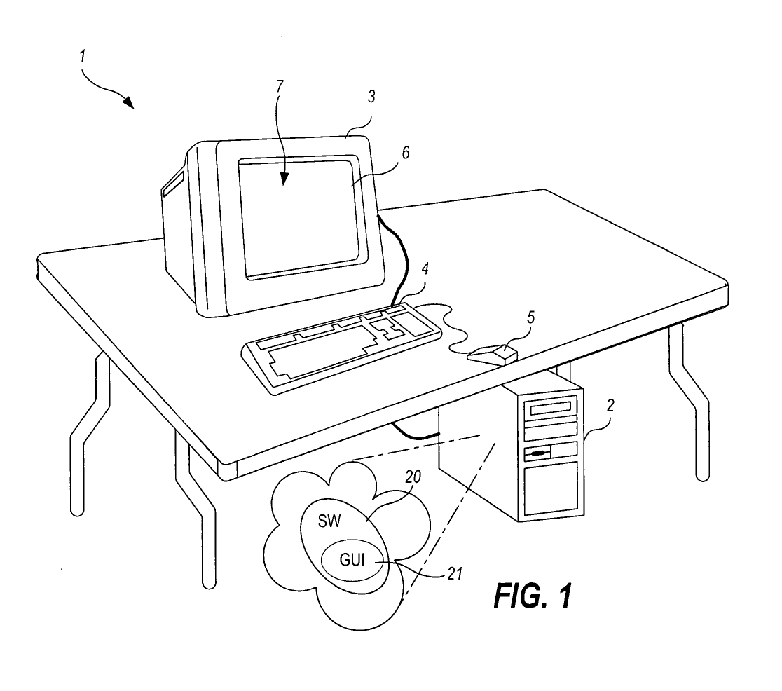

Turning now to the drawings, FIG. 1 is a perspective view of a system 1 in which the invention operates. As illustrated, system 1 includes a computer 2 (for example, a workstation operating under the HP-UX operating system) which runs a software application 20, a display monitor 3 and input keyboard 4 and mouse 5. The software application 20 includes graphical user interface software 21 which receives user input via the keyboard 4 and mouse 5, and presents application output in a user-friendly format on the display screen 6 of the display monitor 3 for comprehension by a human operator. The graphical user interface (GUI) software 21 generates a GUI 7 whose output is rendered on the display screen 6 of the display monitor 3.

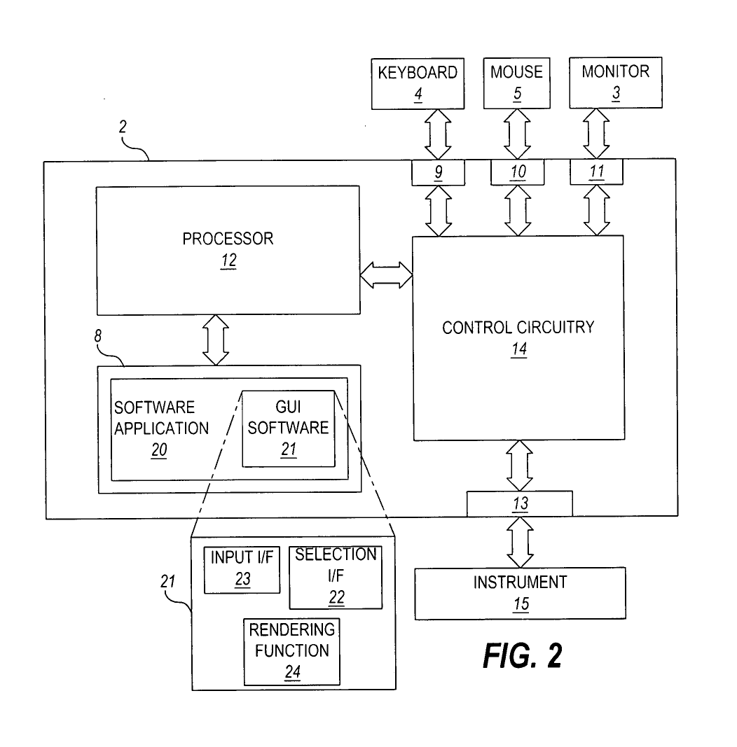

FIG. 2 is a block diagram of the computer system 1 of FIG. 1. As shown therein, the computer 2 includes a processor 12 such as a central processing unit, a microprocessor, microcontroller or other such embedded processing system, a memory 8, control circuitry 14, a keyboard port 9, a mouse port 10, a display monitor port 11, and an optional port 13 for communication with external instruments 15. The processor 12 retrieves and executes application program instructions implementing the software application 20 from memory 8. The application program instructions include GUI software 21 (also in the form of program instructions) which operates to receive and process input from the input keyboard 4 and mouse 5 received at the keyboard port 9 and mouse port 10, respectively, under the control of control circuitry 14. The GUI software 21 also operates to generate output to the display monitor port 11 via control circuitry 14 for rendering on the screen 6 by the display monitor 3.

The inset of FIG. 2 shows the internals of the GUI software 21. As illustrated, the GUI software 21 includes at least a selection interface 22 which present a plurality of selectable graphical identifiers that are respectively associated with one or more element characteristics of possible elements to be displayed, an input interface 23 which detects selection and de-selection of any of the presented selectable graphical identifiers, and a rendering function which, for each selected graphical identifier as detected by the input interface, renders elements possessing the characteristics associated with the selected graphical identifier on the display screen using a different unique rendering color associated with its selected graphical identifier.

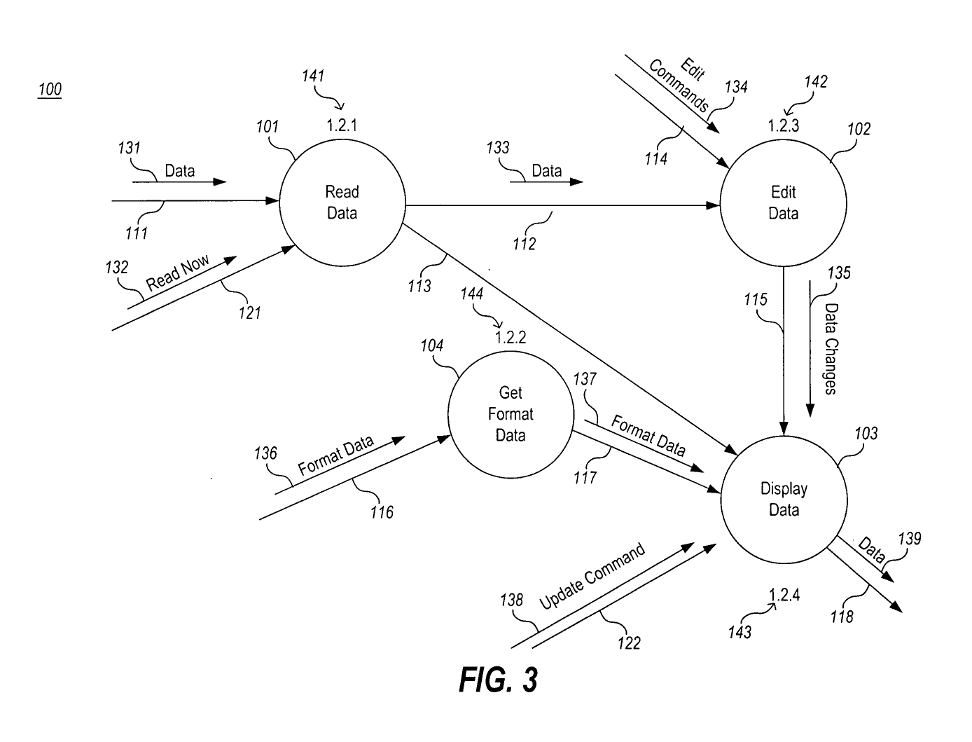

The present invention applies to GUI images that include a plurality of elements that must be visually differentiated from one another by way of a color used to render the element. For purposes of illustration, an example of a GUI image having a plurality of elements to be visually differentiated from one another is presented in FIG. 3 wherein the elements are to be differentiated according to element type. Of course, it will be appreciated that other differentiation criteria may be used, for example, element number, element size, elements associated with specific values for certain characteristics, etc., and that the element differentiation criteria of element type is illustrated herein by way of example only and not limitation.

Turning now to FIG. 3, there is shown therein an example graphical model 100 of a process that includes a plurality of elements, where each element corresponds to one of a plurality of different element types. The element types include data items, data flows, control flows, process bubbles and process numbers. In the illustrative example, elements 131, 132, 133, 134, 135, 136, 137, 138, and 139 correspond to the data item type; elements 111, 112, 113, 114, 115, 116, 117, and 118 correspond to the data flow type, elements 121 and 122 correspond to the control flow type, elements 101, 102, 103, and 104 correspond to the process bubble type, and elements 141, 142, 143, and 144 correspond to the process number type.

The graphical model 100 may be generated, for example, in a graphical editor that allows display of graphical information and manipulation of the displayed information. The graphical model 100 shown in the illustrative embodiment is known as a “Data Flow Diagram”, which is a diagramming convention used as part of a design practice for conveying design ideas called “Structured Analysis/Structured Design” (SA/SD). In the illustrative embodiment, the software application 20 is a graphical editor, used for example in a software design environment or a within a Computer Aided Design (CAD) tool that allows a user to implement SA/SD for a given design by inserting and manipulating icons representing data items, data flows, control flows, process bubbles, and process numbers on the display screen 6. Each icon type (e.g., data items, data flows, control flows, process bubbles, and process numbers) represents different respective predefined functionalities. The icons may often be selected and edited by the user to set parameters specific to the particular element represented by the icon. The resulting graphical model represents a structured design of a process or entity, which may assist the designer or third party in actual implementation of the design. During a SA/SD session, it may be useful to selectively display only elements of a certain type (e.g., only icons representing process bubbles), or to visually differentiate selected elements from other displayed elements of the model on the screen 6. Accordingly, a selection mechanism is required. The selection mechanism may take the form of a menu list with switchably selectable menu items, such as a drop-down list, a pop-up window that may be activated to allow selection/deselection of items, a dedicated panel on the screen, or may be integrated into the panel where the image containing the elements for selection is displayed.

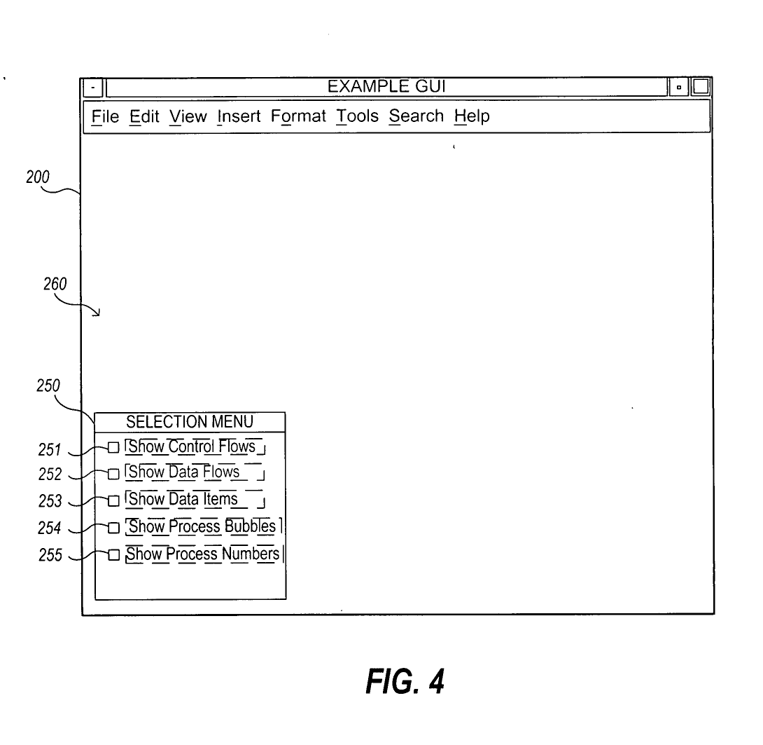

FIG. 4 illustrates a graphical user interface (GUI) window 200 having an image rendering space 260 and a selection menu 250 which allows selection of various element types to be rendered in the image rendering space 260. In this example, the selection menu 250 is presented as a panel in the GUI window 200. However, it will be appreciated that the highlight selection menu may be alternatively presented as a drop-down list with switchably selectable items, a pop-up window, or integrated directly into the image rendering space. As illustrated, the selection menu 250 comprises a plurality of switchably selectable menu items 251, 252, 253, 254, 255, each activated or deactivated via a corresponding checkbox. As illustrated, the menu items 251, 252, 253, 254, 255 correspond to each of the different element types displayable in the graphical model 100 of FIG. 3. Accordingly, the selection menu 250 includes selection item 251 for activating or deactivating display of elements of the control flow type, selection item 252 for activating or deactivating display of elements of the data flow type, selection item 253 for activating or deactivating display of elements of the data item type, selection item 254 for activating or deactivating display of elements of the process bubble type, and selection item 255 for activating or deactivating display of elements of the process number type.

In FIG. 4, the selection menu 250 is displayed with no selection item activated (i.e., none of the menu items 251, 252, 253, 254, 255 indicate that they are selected with an “X” in their corresponding checkboxes); accordingly, the image rendered in the image rendering space 260 of the window 200 is blank.

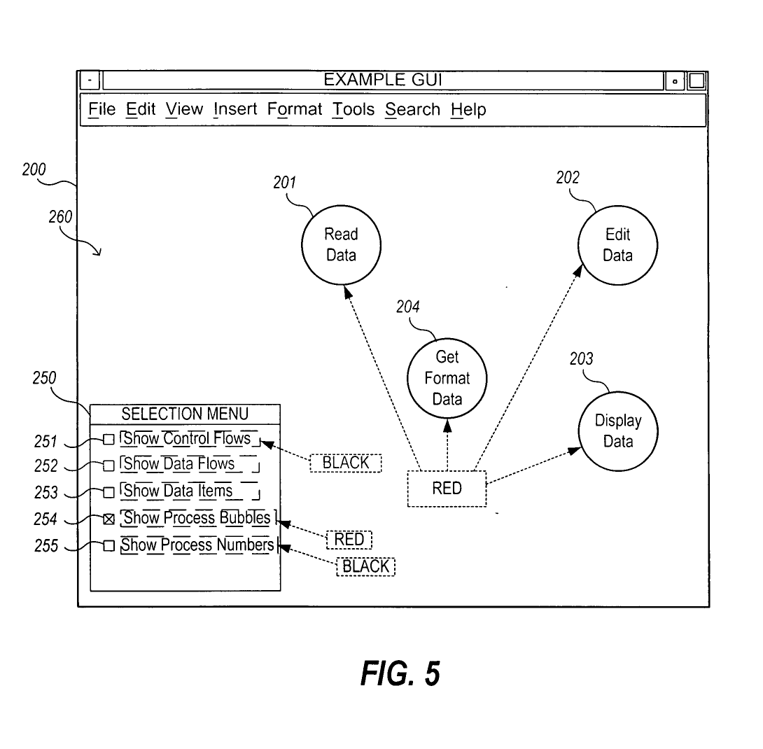

FIG. 5 illustrates the selection menu 250 with the process bubble selection item 254 activated, as indicated by the “X” in its corresponding checkbox, and the remaining selection items 251, 252, 253, and 255 deactivated. Accordingly, only the elements 201, 202, 203, and 204, corresponding to the process bubble element type, are rendered in the image rendering space 260 of the window 200.

When only one element type is selected for display, there is no need to visually differentiate the displayed elements from elements of other types because elements of other types are not displayed. However, when two or more element types are selected for display, the present invention provides a color key inherent in the selection menu for visually differentiating each selected subset from each other selected subsets of elements that are displayed.

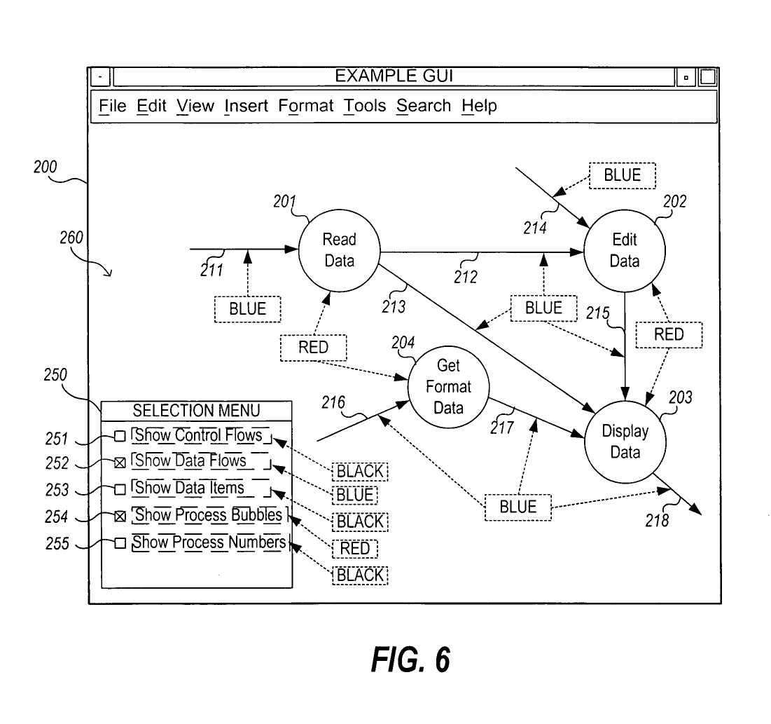

FIG. 6 illustrates such an example. In this example, the selection menu 250 is shown with the data flow selection item 252 and the process bubble selection item 254 activated, as indicated by the “X” in each of their corresponding checkboxes, and the remaining selection items 251, 253, and 255 deactivated. Accordingly, only the elements 211, 212, 213, 214, 215, 216, 217, and 218, corresponding to the data flow element type, and the elements 201, 202, 203, and 204, corresponding to the process bubble element type, are rendered in the image rendering space 260 of the window 200.

In this case, a color key inherent in the selection menu and rendered image is used to visually differentiate between elements belonging to each of the selected sets of rendered elements. To accomplish this, the menu items 251, 252, 253, 254, 255 are each assigned to and rendered with a different rendering color. In conjunction with the color key inherent in the selection menu 250, elements corresponding to an element type corresponding to a selected menu item are rendered using the same color as the color used to render the label of the corresponding selected menu item. Thus, for example, in FIG. 6, data flow selection item 252 is assigned to and rendered with a blue color and the displayed elements 211, 212, 213, 214, 215, 216, 217, and 218, corresponding to the data flow element type, are also rendered with a blue color. The blue color matches that of the data flow selection item 252 in the selection menu 250 to visually indicate that the elements 211, 212, 213, 214, 215, 216, 217, and 218, are data flow elements. In contrast, process bubbles selection item 254 is assigned to and rendered with a red color and the displayed elements 201, 202, 203, and 204, corresponding to the process bubble element type, are also rendered with a red color. The red color matches that of the process bubbles selection item 254 in the selection menu 250 to visually indicate that the elements 201, 202, 203, and 204, are process bubble elements. Thus, the use of different colors for rendering the selection menu items 252 and 254 in combination with the use of the same color to render both a given selection menu item and its corresponding displayed elements operates as an inherent color key within the selection menu 250 without requiring any additional screen space (i.e., pixels).

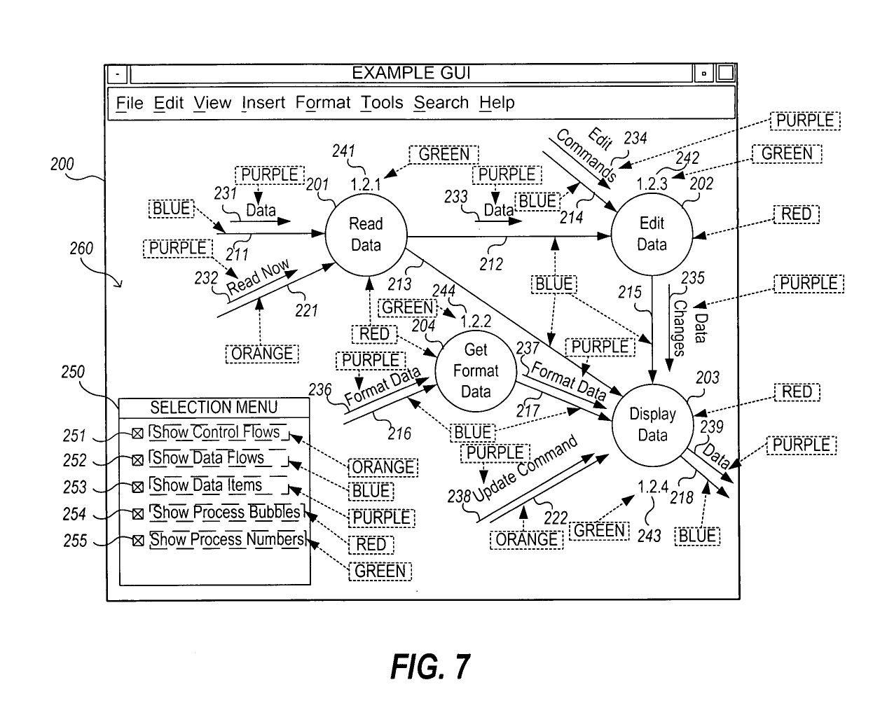

FIG. 7 illustrates the selection menu 250 with all of the selection items activated. Thus, control flow selection item 251, data flow selection item 252, data item selection item 253, process bubble selection item 254, and process number selection item 255 are each activated, as indicated by the “X” in each of their corresponding checkboxes. Accordingly, the rendered image in the image rendering space 260 of the window 200 includes elements 221 and 222, corresponding to the control flow type, elements 211, 212, 213, 214, 215, 216, 217, and 218, corresponding to the data flow element type, elements 231, 232, 233, 234, 235, 236, 237, 238, and 239, corresponding to the data item element type, elements 201, 202, 203, and 204, corresponding to the process bubble element type, and elements 241, 242, 243, and 244, corresponding to the process number element type.

Again, a color key is inherently implemented by use of rendering colors in the selection menu 250 and image rendering space 260. In this example, control flow selection item 251 is assigned to and rendered with an orange color and the displayed elements 221 and 222, corresponding to the control flow element type, are also rendered with an orange color. The orange color matches that of the control flow selection item 251 in the selection menu 250 to visually indicate that the elements 221 and 222 are control flow elements. Data flow selection item 252 is assigned to and rendered with a blue color and the displayed elements 211, 212, 213, 214, 215, 216, 217, and 218, corresponding to the data flow element type, are also rendered with a blue color. The blue color matches that of the data flow selection item 252 in the selection menu 250 to visually indicate that the elements 211, 212, 213, 214, 215, 216, 217, and 218, are data flow elements. Data item selection item 253 is assigned to and rendered with a purple color and the displayed elements 231, 232, 233, 234, 235, 236, 237, 238, and 239, corresponding to the data item element type, are also rendered with a purple color. The purple color matches that of the data item selection item 253 in the selection menu 250 to visually indicate that the elements 231, 232, 233, 234, 235, 236, 237, 238, and 239, are data item elements. Process bubbles selection item 254 is assigned to and rendered with a red color and the displayed elements 201, 202, 203, and 204, corresponding to the process bubble element type, are also rendered with a red color. The red color matches that of the process bubbles selection item 254 in the selection menu 250 to visually indicate that the elements 201, 202, 203, and 204, are process bubble elements. Process numbers selection item 255 is assigned to and rendered with a green color and the displayed elements 241, 242, 243, and 244, corresponding to the process number element type, are also rendered with a green color. The green color matches that of the process numbers selection item 255 in the selection menu 250 to visually indicate that the elements 241, 242, 243, and 244, are process number elements.

Thus, the use of different colors for rendering the selection menu items 251, 252, 253, 254, and 255, in combination with the use of the same color to render both a given selection menu item and its corresponding displayed elements operates as an inherent color key within the selection menu 250 without requiring any additional screen space (i.e., pixels).

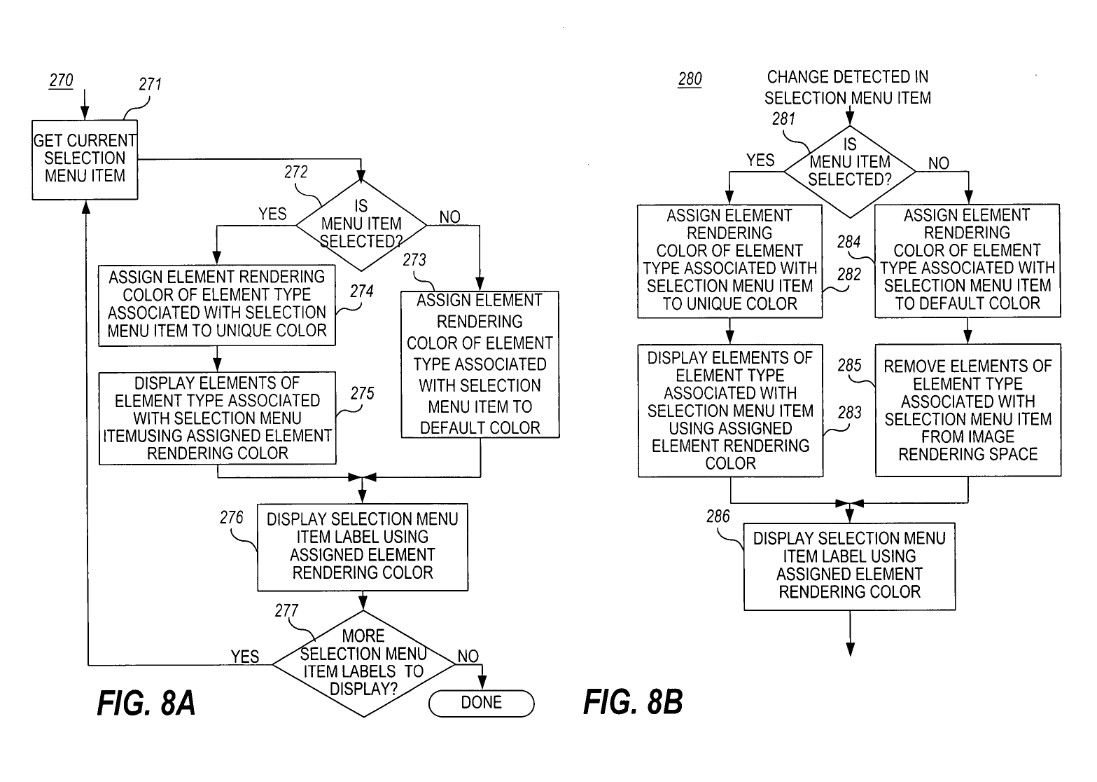

FIG. 8A is a flowchart illustrating a preferred embodiment of a method 270 for implementing the inherent color key in the selection menu 250 of FIGS. 4-7 in a graphical user interface. As illustrated, for each selection menu item (step 271), the method determines whether the current selection menu item is selected (step 272). If not, the method assigns an element rendering color for the element type associated with the current selection menu item to a default color (for example, “black”) (step 273). If in the alternative the current selection menu item is selected, then the method assigns an element rendering color for the element type associated with the current selection menu item to a unique color (step 274). “Unique” color is herein defined to be a color other than the default rendering color and that is different from the element rendering color assigned to any other element type. The method then displays all elements of the element type associated with the current selection menu item using the element rendering color assigned to that element type (step 275). The current selection menu item label is then rendered using the element rendering color assigned to the element type associated with the selection menu item (step 276). The method determines whether more selection menu items need to be displayed (step 277), and repeats the above steps (step 271 through step 277) until all selection menu items have been displayed.

Once the selection menu 250 has been displayed and elements having element types associated with the selected menu items have been rendered in the image rendering space 260, the GUI software monitors user input to detect changes in selected menu items in the selection menu. FIG. 8B is a flowchart illustrating a preferred embodiment of a method 280 for implementing detected changes in the selection menu 250 of FIGS. 4-7. As illustrated, the method determines whether the changed selection menu item is selected (step 281). If the changed selection menu item is selected (i.e., user input has selected the selection menu item when it was previously unselected), then the method assigns an element rendering color for the element type associated with the changed selection menu item to a unique color (step 282). The method then re-displays all elements of the element type associated with the changed selection menu item using the element rendering color assigned to that element type (step 283). If in the alternative the changed selection menu item is unselected (i.e., user input has de-selected the selection menu item when it was previously selected), the method assigns an element rendering color for the element type associated with the changed selection menu item to the default color (for example, “black”) (step 284). The method then removes all elements of the element type associated with the changed selection menu item from the image rendering space of the GUI (step 285). The changed selection menu item label is then re-rendered using the element rendering color assigned to the element type associated with the changed selection menu item (step 266).

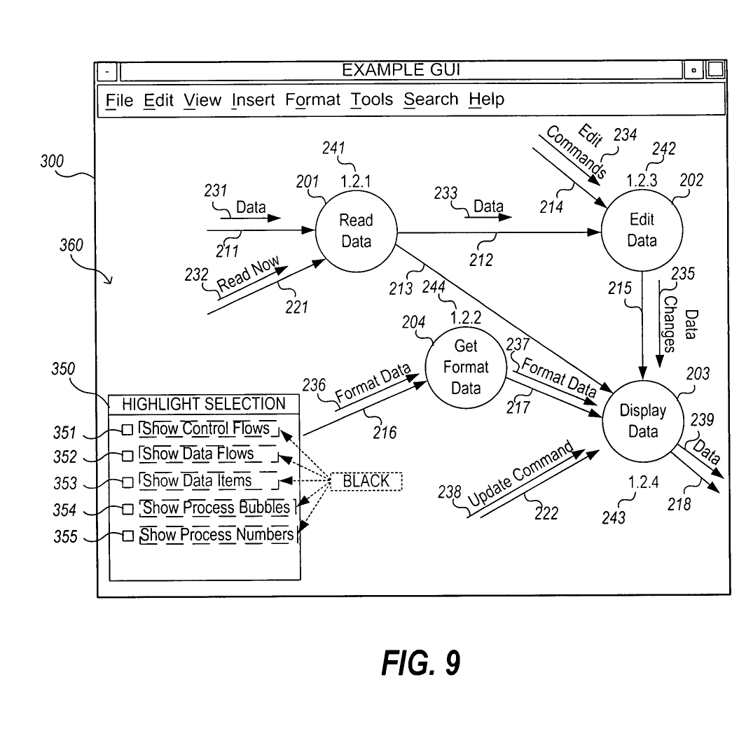

The invention may alternatively be useful during the generation or debug of a graphically generated software program to visually differentiate, or “highlight” certain elements among a plurality of simultaneously displayed elements on the screen 6. Accordingly, a highlight selection mechanism is required. FIG. 9 illustrates a graphical user interface window 300 having an image rendering space 360 and a highlight selection menu 350. In this example, the highlight selection menu 350 is presented as a panel in the GUI window 300. However, it will be appreciated that the highlight selection menu may be alternatively presented as a drop-down list with switchably selectable items, a pop-up window, or integrated directly into the image rendering space. As illustrated, the highlight selection menu 350 comprises a plurality of switchably selectable menu items 351, 352, 353, 354, 355, each activated or deactivated via a corresponding checkbox. As illustrated, the menu items 351, 352, 353, 354, 355 correspond to each of the different element types of the graphical model 100 of FIG. 3. Accordingly, the highlight selection menu 350 includes highlight selection item 351 for activating or deactivating highlighting of elements of the control flow type, highlight selection item 352 for highlighting of elements of the data flow type, highlight selection item 353 for highlighting of elements of the data item type, highlight selection item 354 for highlighting of elements of the process bubble type, and highlight selection item 355 for highlighting of elements of the process number type.

As also illustrated, each highlight selection menu item 351, 352, 353, 354, 355 is rendered using a unique highlight color, corresponding to the color that elements of that type will be rendered in the image rendering space 360 if selected for highlighting. For example, highlight selection menu item 351 is rendered with an orange color, indicating that elements of type control flow displayed in the image rendering space 360 will be rendered with the same orange color if selected for highlighting. Similarly, highlight selection menu item 352 is rendered with a blue color, indicating that elements of type data flow displayed in the image rendering space 360 will be rendered with the same blue color if selected for highlighting. Likewise, highlight selection menu item 353 is rendered with a purple color, indicating that elements of type data item displayed in the image rendering space 360 will be rendered with the same purple color if selected for highlighting. Similarly, highlight selection menu item 354 is rendered with a red color, indicating that elements of type process bubble displayed in the image rendering space 360 will be rendered with the same red color if selected for highlighting. Finally, highlight selection menu item 355 is rendered with a green color, indicating that elements of type process number displayed in the image rendering space 360 will be rendered with the same green color if selected for highlighting.

In FIG. 9, the highlight selection menu 350 is displayed with no highlight selection item activated (i.e., none of the menu items 351, 352, 353, 354, 355 indicate that they are selected with an “X” in their corresponding checkboxes); accordingly, none of the elements 201, 202, 203, 204, 211, 212, 213, 214, 215, 216, 217, 218, 221, 222, 231, 232, 233, 234, 235, 236, 237, 238, 239, 241, 242, 243, 244 rendered in the image rendering space 360 of the window 300 are selected for highlighting, and therefore each element is rendered using a default color (e.g., black), providing no color distinction between any of the displayed elements.

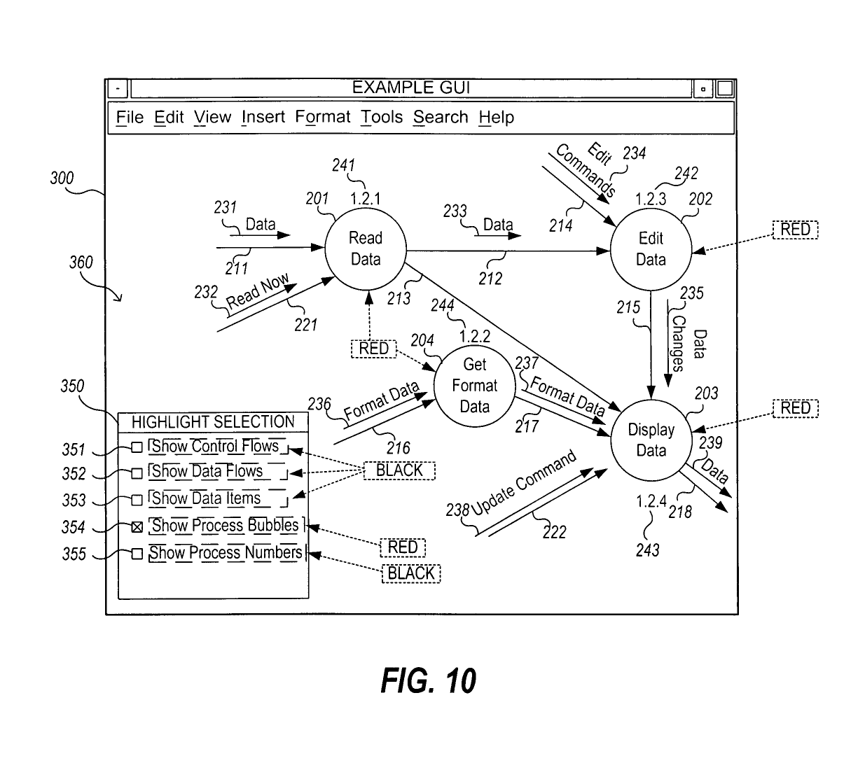

FIG. 10 illustrates the selection menu 350 with the process bubble highlight selection item 354 (rendered in the color red) activated, as indicated by the “X” in its corresponding checkbox, and the remaining highlight selection items 351, 352, 353, and 355 deactivated. Accordingly, the elements 201, 202, 203, and 204, corresponding to the process bubble element type, are rendered using the color red in the image rendering space 360 of the window 300. The remaining elements 211, 212, 213, 214, 215, 216, 217, 218, 221, 222, 231, 232, 233, 234, 235, 236, 237, 238, 239, 241, 242, 243, 244 rendered in the image rendering space 360 of the window 300 are not selected for highlighting, and therefore are rendered using the default color (e.g., black). Thus, visual color differentiation is provided only for the highlighted elements 201, 202, 203, 204.

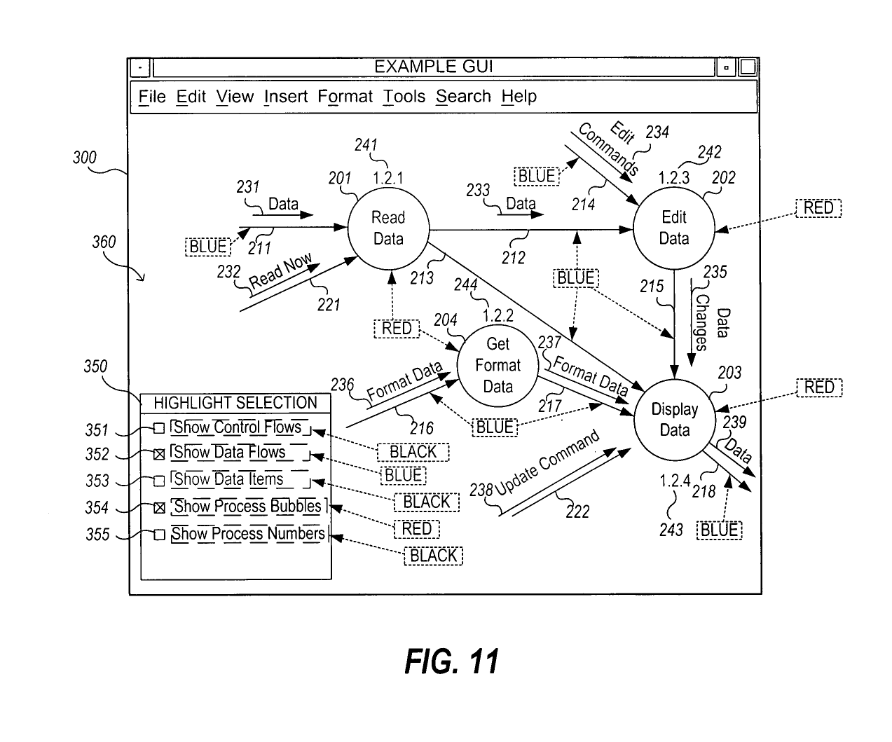

FIG. 11 illustrates the data flow highlight selection item 352 (rendered using the color blue) and the process bubble highlight selection item 354 (rendered using the color red) activated, as indicated by the “X” in each of their corresponding checkboxes, and the remaining selection items 351, 353, and 355 deactivated. Accordingly, the elements 211, 212, 213, 214, 215, 216, 217, and 218, corresponding to the data flow element type, are rendered using the color blue in the image rendering space 360 of the window 300, and the elements 201, 202, 203, and 204, corresponding to the process bubble element type, are rendered using the color red in the image rendering space 360 of the window 300. The remaining elements 221, 222, 231, 232, 233, 234, 235, 236, 237, 238, 239, 241, 242, 243, 244 rendered in the image rendering space 360 of the window 300 are not selected for highlighting, and therefore are rendered using the default color (e.g., black). Thus, visual color differentiation is provided only for the highlighted elements 201, 202, 203, 204, corresponding to the process bubble element type, and elements 211, 212, 213, 214, 215, 216, 217, and 218, corresponding to the data flow element type.

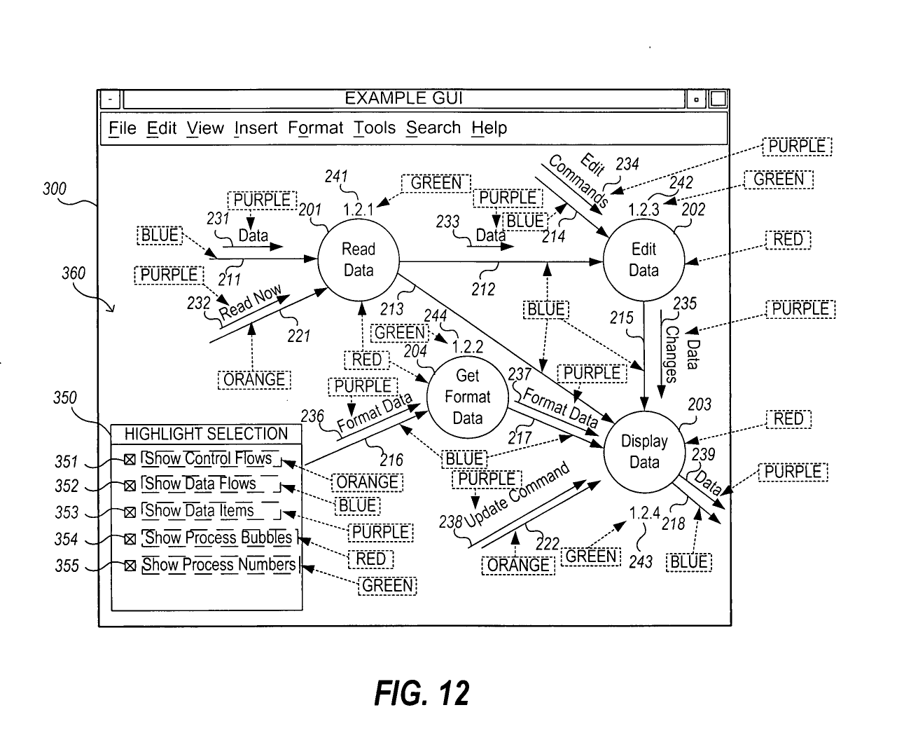

FIG. 12 illustrates the highlight selection menu 350 with all of the selection items activated. Thus, control flow highlight selection item 351 (rendered in the color orange), data flow highlight selection item 352 (rendered in the color blue), data item highlight selection item 353 (rendered in the color purple), process bubble highlight selection item 354 (rendered in the color red), and process number highlight selection item 355 (rendered in the color green) are each activated, as indicated by the “X” in each of their corresponding checkboxes. Accordingly, the elements 221, and 222, corresponding to the control flow element type, are rendered using the color orange in the image rendering space 360 of the window 300, the elements 211, 212, 213, 214, 215, 216, 217, and 218, corresponding to the data flow element type, are rendered using the color blue in the image rendering space 360 of the window 300, the elements 231, 232, 233, 234, 235, 236, 237, 238, and 239, corresponding to the data item element type, are rendered using the color purple in the image rendering space 360 of the window 300, the elements 201, 202, 203, and 204, corresponding to the process bubble element type, are rendered using the color red in the image rendering space 360 of the window 300, and the elements 241, 242, 243, and 244, corresponding to the process number element type, are rendered using the color green in the image rendering space 360 of the window 300. When all highlight selection menu items are activated, visual color differentiation for all element types is shown.

Again, a color key is inherently implemented in the highlight selection menu 360 by use of unique rendering colors for each of the highlight selection menu items 351, 352, 353, 354, 355 in the highlight selection menu 350 and matching rendering colors for each of the elements corresponding to the selection menu items when displayed in the image rendering space 260. Furthermore, the color key is implemented without any additional use of screen space (i.e., use of additional pixels).

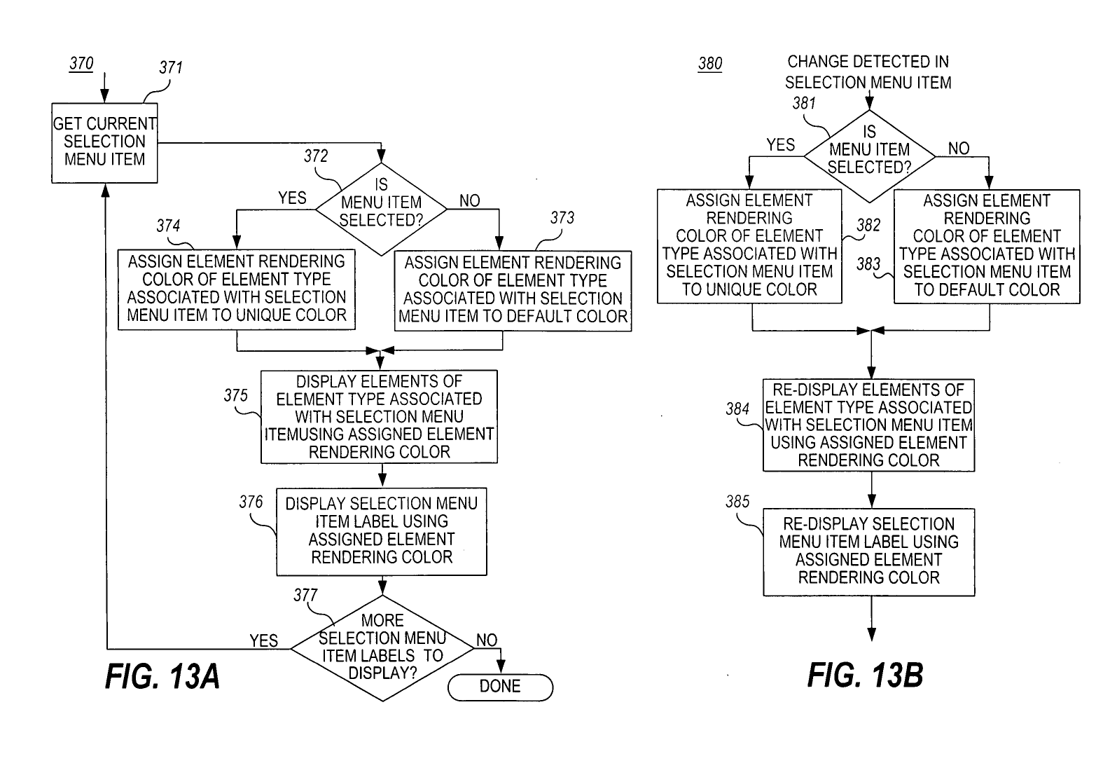

FIG. 13A is a flowchart illustrating a preferred embodiment of a method 370 for implementing the inherent color key in the selection menu 350 of FIGS. 9-12 in a graphical user interface. As illustrated, for each selection menu item (step 371), the method determines whether the current selection menu item is selected (step 372). If not, the method assigns an element rendering color for the element type associated with the current selection menu item to a default color (for example, “black”) (step 373). If in the alternative the current selection menu item is selected, then the method assigns an element rendering color for the element type associated with the current selection menu item to a unique color (step 374). “Unique” color is herein defined to be a color other than the default rendering color and that is different from the element rendering color assigned to any other element type. The current selection menu item label is then rendered using the element rendering color assigned to the element type associated with the selection menu item (step 375). The method then displays all elements of the element type associated with the current selection menu item using the element rendering color assigned to that element type (step 376). The method determines whether more selection menu items need to be displayed (step 277), and repeats the above steps (step 371 through step 377) until all selection menu items have been displayed.

Once the selection menu 350 has been displayed and elements having element types associated with the selected menu items have been rendered in the image rendering space 360, the GUI software monitors user input to detect changes in selected menu items in the selection menu. FIG. 13B is a flowchart illustrating a preferred embodiment of a method 380 for implementing detected changes in the selection menu 350 of FIGS. 9-12. As illustrated, the method determines whether the changed selection menu item is selected (step 381). If the changed selection menu item is selected (i.e., user input has selected the selection menu item when it was previously unselected), then the method assigns an element rendering color for the element type associated with the changed selection menu item to a unique color (step 382). If in the alternative the changed selection menu item is unselected (i.e., user input has de-selected the selection menu item when it was previously selected), the method assigns an element rendering color for the element type associated with the changed selection menu item to the default color (for example, “black”) (step 383). The method then re-displays all elements of the element type associated with the changed selection menu item using the element rendering color assigned to that element type (step 384). The selection menu item label associated with the changed selection menu item is then re-rendered using the element rendering color assigned to the element type associated with the changed selection menu item (step 285).

In the illustrative embodiment presented herein, selection menu items are rendered using their uniquely assigned colors only when the selection menu item has been selected. When de-selected, the selection menu item is rendered in a default color different than any of the rendering colors assigned to the various element types. It is to be understood that the selection menu items may be alternatively rendered using their uniquely assigned colors at all times (i.e., regardless of whether or not the selection menu item has been selected).

Although this preferred embodiment of the present invention has been disclosed for illustrative purposes, those skilled in the art will appreciate that various modifications, additions and substitutions are possible, without departing from the scope and spirit of the invention as disclosed in the accompanying claims. For example, it should be understood that although in the preferred embodiment, the criteria for element selection was the element type; however, the criteria for selection may be any other characteristic of the various elements, for example but not limited to element number, element version, element's use of a specified variable, element's input from a specified source, element's output to a specified destination, element parameter value, etc., as appropriate to the particular application of the graphical user interface in which the inherent color key is implemented. As another example, it should be understood that although in the illustrative embodiment the selection menu and highlight selection menu are implemented as individual panels within the graphical user interface window, the selection menu and highlight selection menu may alternatively be implemented as a drop-down list with switchably selectable list items, a pop-up window that the user optionally activates and which contains the selection/highlight selection menu, or implemented within the image rendering space itself, or using any other technique for presenting a selection menu now known or hereinafter developed. It is also possible that other benefits or uses of the currently disclosed invention will become apparent over time.

1. A graphical user interface application for rendering graphical elements that are characterized by a plurality of element characteristics in an image rendering space on a display screen, said graphical user interface comprising:
a selection interface comprising a plurality of selectable graphical identifiers each of which is associated with a respective one or more of said plurality of element characteristics and associated with a different unique rendering color that is used when rendering said respective selectable graphical identifier when said respective one or more of said plurality of element characteristics associated with said respective selectable graphical identifier is selected for display;
an input interface which detects selection of any of said respective plurality of selectable graphical identifiers; and
a rendering function which, for each detected selected graphical identifier, renders elements characterized by said respective one or more of said plurality of element characteristics associated with said selected graphical identifier in said image rendering space of said display screen using said different unique rendering color associated with said selected graphical identifier.

2. A graphical user interface application in accordance with claim 1, wherein:
upon detection by said input interface of a newly selected one of any of said plurality of selectable graphical identifiers that are not currently selected, said rendering function renders elements characterized by said respective one or more of said plurality of element characteristics associated with said newly selected graphical identifier in said image rendering space of said display screen using said different unique rendering color associated with said newly selected graphical identifier.

3. A graphical user interface application in accordance with claim 2, wherein:
said rendering function re-renders said newly selected graphical identifier using said different unique rendering color associated with said newly selected graphical identifier.

4. A graphical user interface application in accordance with claim 1, wherein:
upon detection by said input interface of de-selection of any currently selected graphical identifiers, said rendering function removes from said image rendering space of said display screen any element that is not characterized by said respective one or more of said plurality of element characteristics associated with any of said remaining selected graphical identifiers.

5. A graphical user interface application in accordance with claim 4, wherein:
said rendering function re-renders said de-selected graphical identifier using a default color.

6. A graphical user interface application in accordance with claim 3, wherein:
upon detection by said input interface of de-selection of any currently selected graphical identifiers, said rendering function removes from said image rendering space of said display screen any element that is not characterized by said respective one or more of said plurality of element characteristics associated with any of said remaining selected graphical identifiers.

7. A graphical user interface application in accordance with claim 6, wherein:
said rendering function re-renders said de-selected graphical identifier using a default color.

8. A graphical user interface application in accordance with claim 1, wherein:
said rendering function renders any element that is not characterized by said respective one or more of said plurality of element characteristics associated with any of said selected graphical identifiers in said image rendering space of said display screen using a default rendering color that is different from any of said different unique rendering colors associated with any of said selected graphical identifiers.

9. A graphical user interface application in accordance with claim 8, wherein:
upon detection by said input interface of a newly selected one of any of said plurality of selectable graphical identifiers that are not currently selected, said rendering function re-renders elements characterized by said respective one or more of said plurality of element characteristics associated with said newly selected graphical identifier in said image rendering space of said display screen using said different unique rendering color associated with said newly selected graphical identifier.

10. A graphical user interface application in accordance with claim 9, wherein:
said rendering function re-renders said newly selected graphical identifier using said different unique rendering color associated with said newly selected graphical identifier.

11. A graphical user interface application in accordance with claim 9, wherein:
upon detection by said input interface of de-selection of any currently selected graphical identifiers, said rendering function re-renders in said image rendering space of said display screen any element that is not characterized by said respective one or more of said plurality of element characteristics associated with any of said selected graphical identifiers using said default rendering color.

12. A graphical user interface application in accordance with claim 11, wherein:
said rendering function re-renders said de-selected graphical identifier using said default color.

13. A graphical user interface displayable on a display screen, comprising:
a user selection menu comprising a plurality of selectable graphical identifiers each of which is associated with a respective one or more of said plurality of element characteristics and associated with a different unique rendering color that is used when rendering said respective selectable graphical identifier when said respective one or more of said plurality of element characteristics associated with said respective selectable graphical identifier is selected for display, wherein each of said selectable graphical identifiers are responsive to user selection input for selection of said respective graphical identifier and are responsive to user de-selection input for de-selection of said respective graphical identifier; and
an image rendering space which, for each selected graphical identifier, displays elements characterized by said respective one or more of said plurality of element characteristics associated with said selected graphical identifier in said image rendering space of said display screen using said different unique rendering color associated with said selected graphical identifier, and does not display elements characterized by said respective one or more of said plurality of element characteristics associated with any of said unselected graphical identifiers in said image rendering space of said display screen.

14. A graphical user interface in accordance with claim 13, wherein:
upon user selection input for selection of a newly selected graphical identifier, said image rendering space displays elements characterized by said respective one or more of said plurality of element characteristics associated with said newly selected graphical identifier using said different unique rendering color associated with said newly selected graphical identifier.

15. A graphical user interface in accordance with claim 14, wherein:
said user selection menu displays said newly selected graphical identifier using said different unique rendering color associated with said newly selected graphical identifier.

16. A graphical user interface in accordance with claim 13, wherein:
upon user selection input for de-selection of a currently selected graphical identifier, any element that is not characterized by said respective one or more of said plurality of element characteristics associated with any of said remaining selected graphical identifiers is removed from said image rendering space.

17. A graphical user interface in accordance with claim 16, wherein:
said user selection menu re-displays said de-selected graphical identifier using a default color.

18. A graphical user interface in accordance with claim 15, wherein:
upon user selection input for de-selection of a currently selected graphical identifier, any element that is not characterized by said respective one or more of said plurality of element characteristics associated with any of said remaining selected graphical identifiers is removed from said image rendering space.

19. A graphical user interface in accordance with claim 18, wherein:
said user selection menu re-displays said de-selected graphical identifier using a default color.

20. A method for rendering graphical elements that are characterized by a plurality of element characteristics in an image rendering space of a display screen, said method comprising the steps of:
providing a plurality of selectable graphical identifiers each of which is associated with a respective one or more of said plurality of element characteristics and associated with a different unique rendering color that is used when rendering said respective selectable graphical identifier when said respective one or more of said plurality of element characteristics associated with said respective selectable graphical identifier is selected for display;
detecting selection and/or de-selection of any of said respective plurality of selectable graphical identifiers; and
for each detected selected graphical identifier, rendering elements characterized by said respective one or more of said plurality of element characteristics associated with said selected graphical identifier in said image rendering space of said display screen using said different unique rendering color associated with said selected graphical identifier.

21. A method in accordance with claim 20, further comprising the step of:
upon detection by said input interface of a newly selected one of any of said plurality of selectable graphical identifiers that are not currently selected, rendering elements characterized by said respective one or more of said plurality of element characteristics associated with said newly selected graphical identifier in said image rendering space of said display screen using said different unique rendering color associated with said newly selected graphical identifier.

22. A method in accordance with claim 21, further comprising the step of:
re-rendering said newly selected graphical identifier using said different unique rendering color associated with said newly selected graphical identifier.

23. A method in accordance with claim 20, further comprising the step of:
upon detection by said input interface of de-selection of any currently selected graphical identifiers, removing from said image rendering space of said display screen any element that is not characterized by said respective one or more of said plurality of element characteristics associated with any of said remaining selected graphical identifiers.

24. A method in accordance with claim 23, further comprising the step of:
re-rendering said de-selected graphical identifier using a default color.

25. A method in accordance with claim 22, further comprising the step of:
upon detection by said input interface of de-selection of any currently selected graphical identifiers, removing from said image rendering space of said display screen any element that is not characterized by said respective one or more of said plurality of element characteristics associated with any of said remaining selected graphical identifiers.

26. A method in accordance with claim 25, further comprising the step of:
re-rendering said de-selected graphical identifier using a default color.

27. A method in accordance with claim 20, further comprising the step of:
rendering any element that is not characterized by said respective one or more of said plurality of element characteristics associated with any of said selected graphical identifiers in said image rendering space of said display screen using a default rendering color that is different from any of said different unique rendering colors associated with any of said selected graphical identifiers.

28. A method in accordance with claim 27, further comprising the step of:
upon detection by said input interface of a newly selected one of any of said plurality of selectable graphical identifiers that are not currently selected, re-rendering elements characterized by said respective one or more of said plurality of element characteristics associated with said newly selected graphical identifier in said image rendering space of said display screen using said different unique rendering color associated with said newly selected graphical identifier.

29. A method in accordance with claim 28, further comprising the step of:
re-rendering said newly selected graphical identifier using said different unique rendering color associated with said newly selected graphical identifier.

30. A method in accordance with claim 28, further comprising the step of:
upon detection by said input interface of de-selection of any currently selected graphical identifiers, re-rendering in said image rendering space of said display screen any element that is not characterized by said respective one or more of said plurality of element characteristics associated with any of said selected graphical identifiers using said default rendering color.

31. A method in accordance with claim 30, further comprising the step of:
re-rendering said de-selected graphical identifier using said default color.

32. A computer readable storage medium tangibly embodying program instructions implementing a method for rendering graphical elements that are characterized by a plurality of element characteristics in an image rendering space of a display screen, said method comprising the steps of:
providing a plurality of selectable graphical identifiers each of which is associated with a respective one or more of said plurality of element characteristics and associated with a different unique rendering color that is used when rendering said respective selectable graphical identifier when said respective one or more of said plurality of element characteristics associated with said respective selectable graphical identifier is selected for display;
detecting selection and/or de-selection of any of said respective plurality of selectable graphical identifiers; and
for each detected selected graphical identifier, rendering elements characterized by said respective one or more of said plurality of element characteristics associated with said selected graphical identifier in said image rendering space of said display screen using said different unique rendering color associated with said selected graphical identifier.

33. The computer readable storage medium of claim 32, further comprising the step of:
upon detection by said input interface of a newly selected one of any of said plurality of selectable graphical identifiers that are not currently selected, rendering elements characterized by said respective one or more of said plurality of element characteristics associated with said newly selected graphical identifier in said image rendering space of said display screen using said different unique rendering color associated with said newly selected graphical identifier.

34. The computer readable storage medium of claim 33, further comprising the step of:
re-rendering said newly selected graphical identifier using said different unique rendering color associated with said newly selected graphical identifier.

35. The computer readable storage medium of claim 32, further comprising the step of:
upon detection by said input interface of de-selection of any currently selected graphical identifiers, removing from said image rendering space of said display screen any element that is not characterized by said respective one or more of said plurality of element characteristics associated with any of said remaining selected graphical identifiers.

36. The computer readable storage medium of claim 35, further comprising the step of:
re-rendering said de-selected graphical identifier using a default color.

37. The computer readable storage medium of claim 35, further comprising the step of:
upon detection by said input interface of de-selection of any currently selected graphical identifiers, removing from said image rendering space of said display screen any element that is not characterized by said respective one or more of said plurality of element characteristics associated with any of said remaining selected graphical identifiers.

38. The computer readable storage medium of claim 37, further comprising the step of:
re-rendering said de-selected graphical identifier using a default color.

39. The computer readable storage medium of claim 32, further comprising the step of:
rendering any element that is not characterized by said respective one or more of said plurality of element characteristics associated with any of said selected graphical identifiers in said image rendering space of said display screen using a default rendering color that is different from any of said different unique rendering colors associated with any of said selected graphical identifiers.

40. The computer readable storage medium of claim 39, further comprising the step of:
upon detection by said input interface of a newly selected one of any of said plurality of selectable graphical identifiers that are not currently selected, re-rendering elements characterized by said respective one or more of said plurality of element characteristics associated with said newly selected graphical identifier in said image rendering space of said display screen using said different unique rendering color associated with said newly selected graphical identifier.

41. The computer readable storage medium of claim 40, further comprising the step of:
re-rendering said newly selected graphical identifier using said different unique rendering color associated with said newly selected graphical identifier.

42. The computer readable storage medium of claim 40, further comprising the step of:
upon detection by said input interface of de-selection of any currently selected graphical identifiers, re-rendering in said image rendering space of said display screen any element that is not characterized by said respective one or more of said plurality of element characteristics associated with any of said selected graphical identifiers using said default rendering color.

43. The computer readable storage medium of claim 42, further comprising the step of:
re-rendering said de-selected graphical identifier using said default color.
